(19) United States
(12) Patent Application Publication
(10) Pub. No.: US 2018/0123901 A1
(43) Pub. Date: May 3, 2018

(54) DISTRIBUTED CALCULATION OF CUSTOMER BANDWIDTH UTILIZATION MODELS

(71) Applicant: Level 3 Communication, LLC, Broomfield, CO (US)

(72) Inventors: Sergey YERMAKOV, Littleton, CO (US); Travis Duane EWERT, Highlands Ranch, CO (US)

(21) Appl. No.: 15/339,188

(22) Filed: Oct. 31, 2016

(51) Int. Cl. H04L 12/24; H04L 12/26; H04L 12/751; G06N 99/00

(52) U.S. Cl. CPC H04L 41/145; H04L 43/0894; H04L 41/0213; G06N 99/005; H04L 45/08

(57) ABSTRACT

In embodiments, methods and apparatus are disclosed for predicting bandwidth utilization for a customer of a connectivity service provider. A model that predicts bandwidth utilization is trained in a distributed manner at the network interface devices which connect customer networks to a connectivity service provider network, rather than in a centralized manner at a data center within the service provider network. The network interface devices leverage the storage of an aggregation server and the structure of bandwidth utilization trends to reduce the resources required to calculate the models. The distributed methodology allows for improved scalability in training bandwidth utilization models for all of the customers of the connectivity service provider. Relying on the periodicity of the bandwidth utilization, the method further includes predicting, using the trained model, future bandwidth utilization over time, and the identification and flagging of potential network faults when bandwidth utilization fails to meet expectations.

### BACKGROUND

### Field

This field is generally related to analyzing bandwidth utilization data of network customers.

### Related Art

Data describing how much bandwidth a customer uses can be collected from the routers in a connectivity service provider environment. In a connectivity service provider environment, a customer's bandwidth utilization follows periodical patterns. For example, end users of a commercial customer (e.g., a corporation) work mostly between 9 AM-5 PM during Monday-Friday. As such, the customer's bandwidth utilization would typically be high on these days between 9 AM-5 PM and low outside of these windows. Similarly, the customer's bandwidth utilization may have peaks between 10 AM-11 AM and 2 PM-3 PM every day, and dips around 12 PM-1 PM (lunch hour). Additionally, bandwidth utilization of a customer that performs data backups on Sundays is expected to exhibit weekly peaks during the backup times every Sunday.

Network services may provide connectivity from a customer network to another computer network, such as the Internet. A customer connects to a server using a connectivity service provided by a connectivity service provider's network. Customers are often interested in analyzing the traffic streaming to or from their customers. This can aid customers in determining how much network capacity they should purchase from the customer service provider. It can also help customers to determine potential issues within their network, such as malicious users or a network fault within their own networks.

### SUMMARY

In an embodiment, a method is disclosed for predicting bandwidth utilization for a customer of a connectivity service provider. In the exemplary embodiment, a connectivity service provider network provides internet and other network connectivity services to a client network via network interface devices. The network interface devices serve as the final hop within the connectivity service provider network to connect the client networks to the connectivity service provider network. Each network interface device collects utilization data measuring the bandwidth utilization of the client networks served by the device, and uses the utilization data to create a bandwidth utilization model, or update an existing one using machine learning (ML) methods.

The bandwidth utilization model describes the expected bandwidth usage for that customer for a particular time period within a week, for example, a particular day of the week. The model predicts usage for small time slices within that time period that can range from 1 minute to many hours depending on the desired granularity by the client or the connectivity service provider. The model for the time period works well to approximate future bandwidth utilization for similar future time periods under nominal conditions of both the client and connectivity service provider networks. This is because usage tends to be periodic for similar periods of time, for example, Mondays would tend to exhibit similar bandwidth utilization for a client network serving an office building.

The machine learning methods can be run as “online” or “batch” processes. The “online” process updates an existing model as soon as new utilization data becomes available at the network interface device, updating several times within the time period that the bandwidth utilization model is modeling. The “batch” process waits for the time period to complete, and uses all utilization data collected by the network interface device for that time period to update the bandwidth utilization model once at a time shortly after the time period expires.

Due to the limited resources available on a network interface device, exemplary embodiments also disclose methods by which the network interface device can calculate the bandwidth utilization models and outsource the storage of these models to an aggregation server with much larger resources. The network interface device can then remove the model and utilization data from its memory, thereby keeping the processing resources manageable over time. The aggregation server also sends existing bandwidth utilization models for the upcoming time period to the network interface device so that it can perform its update using the new utilization data collected for that time period. The aggregation server is responsible for coordinating the communication between all of the network interface devices in the network and itself to avoid overload or denial-of-service issues.

The aggregation server is also responsible for using existing bandwidth utilization models to make predictions of the usage for a time period, and compare those predictions to the current bandwidth utilization by the client network. It can alarm and perform several actions when it detects that the current utilization for that client network is above or below the predicted utilization by an unacceptable level.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1A is a diagram of a system that determines a bandwidth utilization model at a centralized aggregation server.

FIG. 1B is a diagram of a system that determines a bandwidth utilization model in a distributed fashion at a network interface device.

FIG. 1C is an example graph depicting bandwidth utilization over time for a customer of a connectivity service provider, according to an embodiment.

FIG. 2A is an embodiment of the connectivity service provider including network interface devices that determine bandwidth utilization models and multiple modules for collecting and storing utilization data and the bandwidth utilization models.

FIG. 2B is an embodiment of a network interface device (NID) including the modules for serving customer traffic, storing utilization data, and calculating bandwidth utilization models.

FIG. 3 is an embodiment of an aggregation server that centrally stores utilization data and bandwidth utilization models, and interfaces to display to customers their desired statistics.

FIG. 4 is a flowchart showing how future bandwidth utilization is predicted.

FIG. 5A is a flowchart for a method to calculate a bandwidth utilization model at a network interface device (NID) using the “online” learning mode.

FIG. 5B is a flowchart for a method to calculate a bandwidth utilization model at a NID using the “batch” learning mode.

FIG. 5C is a flowchart showing the lifecycle of a bandwidth utilization model at a NID.

FIG. 6 is a flowchart for a method to receive bandwidth utilization data and bandwidth utilization models, and determine whether a customer network or connectivity service needs monitoring or trouble shooting at an aggregation server.

The drawing in which an element appears is typically indicated by the leftmost digit or digits in the corresponding reference number. In the drawings, like reference numbers may indicate identical or functionally similar elements.

### DETAILED DESCRIPTION

The following detailed description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

In an embodiment, a set of client networks is served by a connectivity service provider network. The connectivity service provider network is a network that provides internet and other network connectivity services to one or multiple clients, serving as a “middleman” network between a local area network (LAN) of a client and other data servers and the internet. The connectivity service provider sells connectivity services to clients limited by certain common metrics such as maximum instantaneous bandwidth as measured in bits per second (BPS) or maximum total ingress and egress traffic for the client network and serves them through this network.

Given the periodical nature of bandwidth utilization that is typical of many client networks, historical bandwidth utilization data for a customer is collected and analyzed to learn the bandwidth utilization pattern of a customer during an interval of the periodicity (e.g., day, week, or month) by a connectivity service provider (CSP). To learn the bandwidth utilization pattern of a customer during a periodicity interval, machine learning techniques such as regression and kernel methods may be applied within the connectivity service provider network, and using this technique, the bandwidth utilization may be forecasted. In the current invention, the machine learning technique is applied for each client network, indexed by a “circuit” and its associated “circuit network identifier.” The processes applying the machine learning techniques occur at a network interface device that serves as an edge, or “gateway,” routers into the connectivity service provider network.

Regression is a statistical process for estimating a relationship between variables, including relationship between a dependent variable (e.g., bandwidth utilization) versus an independent variable (e.g., time). The relationship between variables will be related by one or more parameters. For example, in a linear regression model with one dependent variable and one independent variable, the statistical process results in the determination of two or more parameters, referred to as a “slope” and “intercept.” In embodiments, the regression technique applied to a time series describing bandwidth utilization over time is based on both linear and non-linear kernel methods. Kernel methods are a class of algorithms used in machine learning (both regression and classification) that rely on kernel functions. In the exemplary embodiment, the radial basis function (RBF) kernel function is used. In other embodiments, several kernels can also be used to achieve the same goal (e.g. Gaussian, Polynomial, Spline, Laplacian, etc.). In an embodiment, the learned bandwidth utilization pattern during a periodicity interval may be used to predict bandwidth utilization of the customer during future periodicity intervals.

It is often helpful for a customer to visually study its historical and forecasted bandwidth utilization. For example, the customer may use this visual study to identify whether it has purchased the right amount of network capacity from the connectivity service provider (CSP). Additionally, the customer may compare previously predicted bandwidth utilization data for a time interval with the real bandwidth utilization data later received for the same time interval and identify potential discrepancies.

The discrepancies may, for example, indicate faulty network components such as gateways or cables, or reveal malicious network activities such as network or security attacks. In an example, one or more end user machines of a customer may be compromised and unwillingly participate in malicious network activities 24 hours a day. In this example, daily bandwidth utilization pattern of the customer may show significant difference with the previously predicted bandwidth utilization data based on historical daily bandwidth utilization. Studying such discrepancies may help the customer identify this problem.

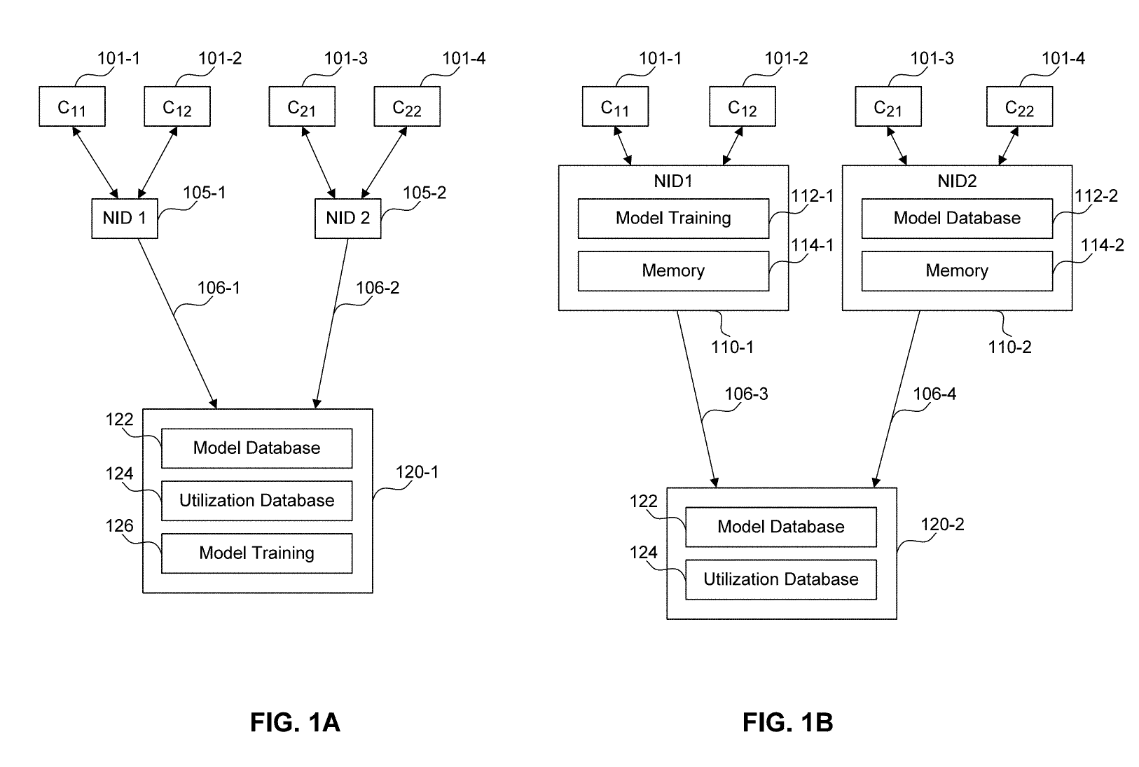

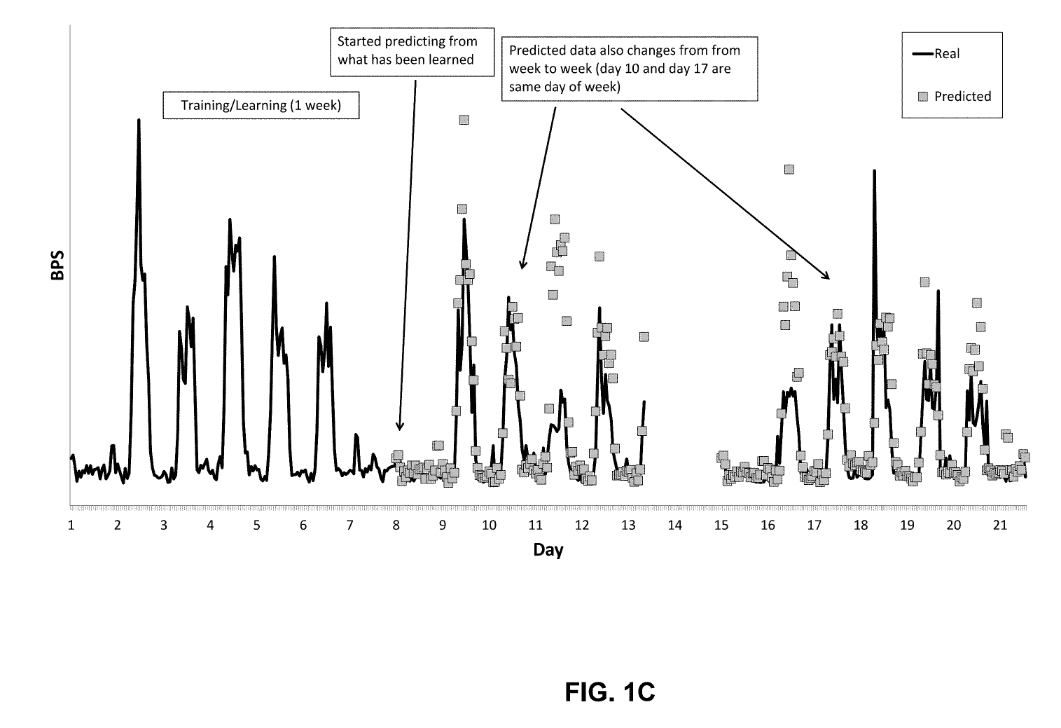

FIG. 1A illustrates a system for determining the bandwidth utilization models that aide in the customer's evaluation of their bandwidth utilization provisioning and detection of potential network fault issues in a centralized manner. In the system depicted, client nodes 101-1 through 101-4 are served by two different NID devices 105-1 and 105-2 owned by a connectivity service provider. The client nodes may represent small local area networks (LANs) that serve particular enterprise or personal user, such as a network serving an office building or storefront owned by a particular customer. Each client node is indexed by a “circuit” with an accompanying “circuit identifier,” which is a unique identifier which may contain metadata related to which NID is serving the client node, the customer's name, service type, and so on.

It should be noted that a single customer can own several client nodes, for example a “customer A” may own networks 101-1 and 101-3 while a customer B and C may own networks 101-2 and 101-3 respectively. Regardless, utilization data and predictions are reported per circuit. A customer purchases service capacity in the form of bandwidth from the connectivity service provider for each client node that it wishes to provide service to.

The NID devices serve as the final hop controlled by a connectivity service provider, i.e. they are the edge routers for the connectivity service provider's network. These nodes may also be referred to as “gateway” nodes for the connectivity service provider. The NID devices in this illustration serve two purposes. The first is to route client traffic to and from aggregation routers (not pictured) which then connect to a wider data network such as the internet. In this function they essentially serve the role of any typical data network router. Their other role is to calculate statistics about each client node's bandwidth utilization and send that data to an aggregation server 120-1. These statistics may be calculated on egress or ingress traffic for each circuit being served by the NID device. For simplicity, the diagram only shows two NIDs, but in general, potentially hundreds of NIDs may be present in a single connectivity service provider network.

The aggregation server 120-1 comprises multiple modules. These modules may be implemented on software on a shared physical system such as a server or data center, or they may be contained on separate physical devices. The utilization database 124 stores the utilization data sent from the NIDs for long-term storage. The model training module 126 is responsible for calculating the bandwidth utilization models for each circuit. This training is done using a kernel method class of algorithms, which will be discussed in further detail. The key issue to understand is that in this configuration, the single model training module is responsible for calculating the bandwidth utilization models for all of the circuits being served by this customer service provider network. As the number of NIDs and circuits within the connectivity service provider network grows, the resources required for the training module to perform the training may grow unacceptably large. Finally, the model database 122 serves as a storage for the most recent updates to the bandwidth utilization models for each circuit. The aggregation server also serves as a centralized hub for customers to retrieve the utilization data and prediction data for each of their client nodes.

FIG. 1B illustrates a system for determining the same bandwidth utilization models using a distributed methodology. In this case, the same client nodes 101-1 through 101-4 are served by two NIDs 110-1 and 110-2 in a similar configuration. However, the NIDs in this model now contain two modules, a memory 114-1 (or 114-2) and a model training module 112-1 (or 112-2). These two modules can be implemented in software on a single NID device, which generally will contain surplus memory for storage and computing resources in the form of processors for some general uses.

In this scenario, the bandwidth utilization models are calculated on each NID for the circuits being served by that NID. Because the number of circuits per NID is limited compared to the number of circuits for the overall connectivity service provider network, the amount of processing resources required to train those models on each NID is within the latent processing and storage capabilities within that ND.

Aggregation server 120-2 still exists, but is significantly less burdened as a result of the shift of the training burden onto each NID. The computing resources required to calculate the bandwidth utilization models for each circuit served by the connectivity service provider network are no longer taken. Therefore, the only operative modules on aggregation server 120-2 in this scenario are the model database 122, and the utilization database 124. The NIDs now send both utilization data and updated bandwidth utilization model data to the aggregation server for storage. Aggregation server 120-2 still serves as the centralized hub for customers to retrieve the utilization data and prediction data for each of their client nodes.

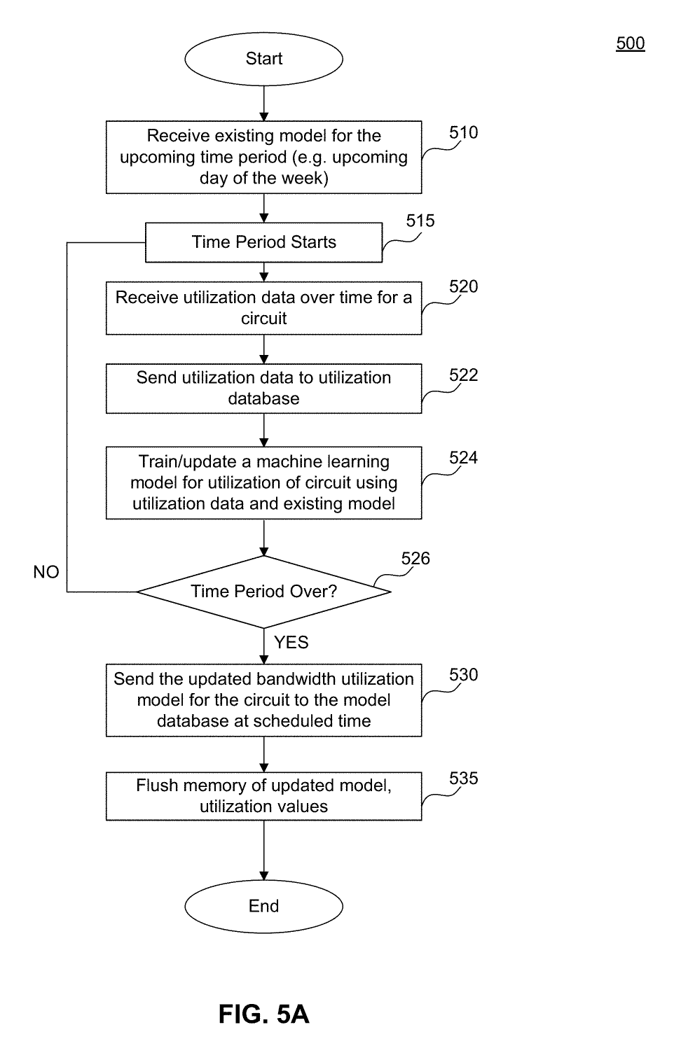

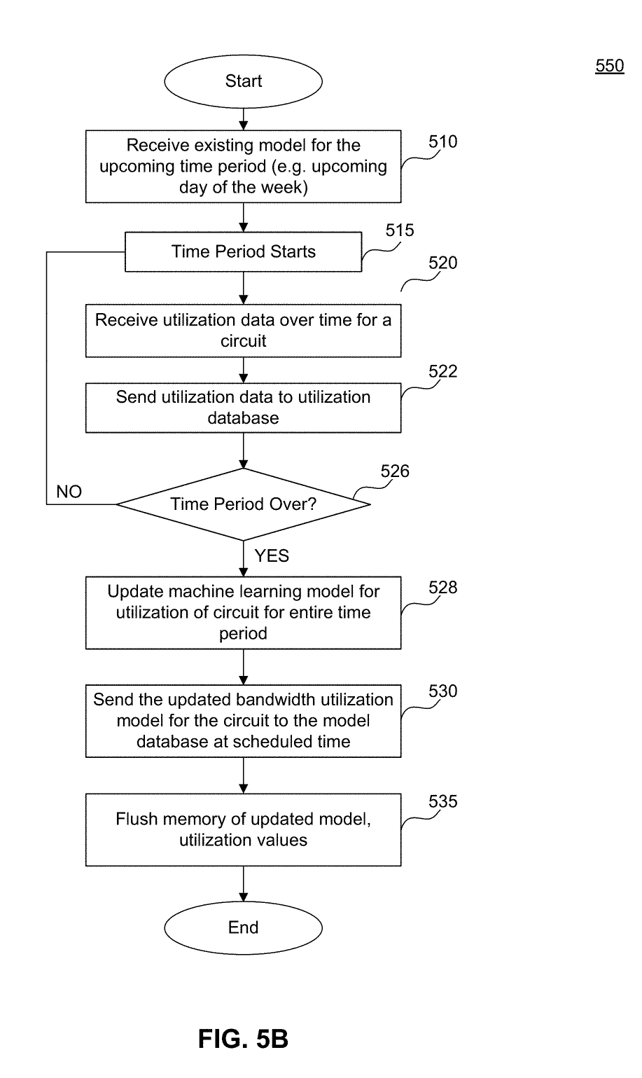

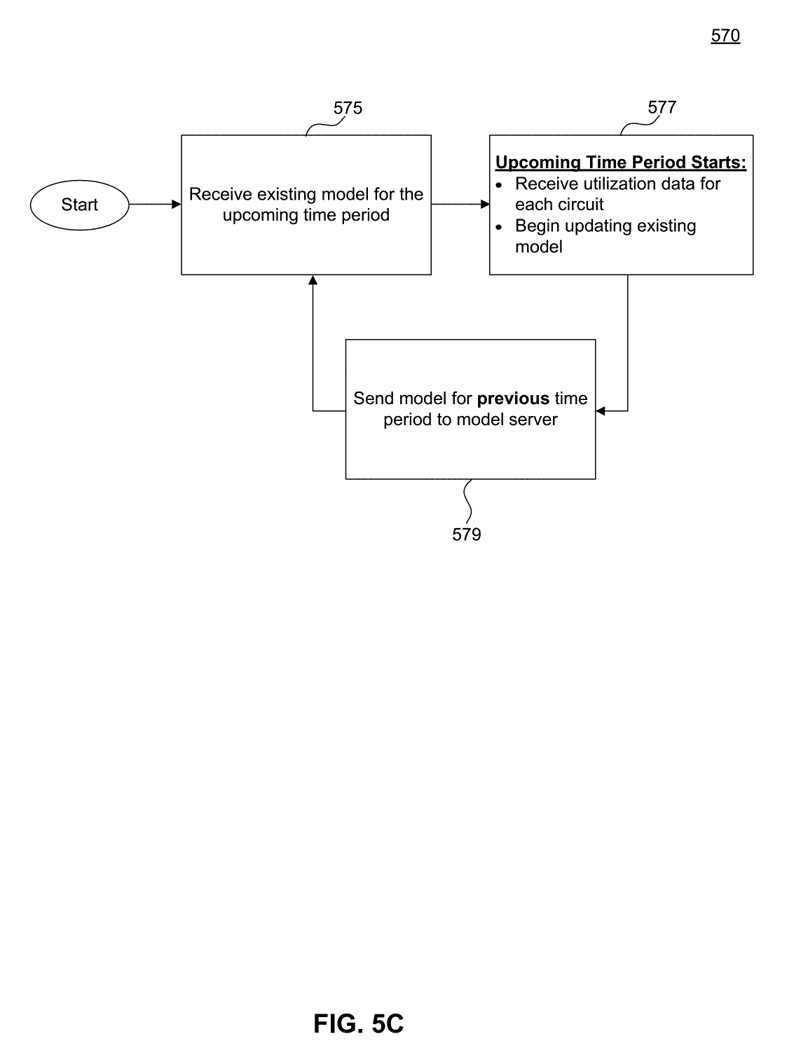

FIG. 1C is an example graph depicting bandwidth utilization over time for a client node, according to an embodiment. In FIG. 1C, an example bandwidth utilization over time for a client node during 20 consecutive days (starting from day 1 which is a Sunday) is illustrated. The solid graph corresponds to observed bandwidth utilization whereas the dotted plot corresponds to predicted bandwidth utilization. The method used to perform the prediction will be shortly described with respect to FIG. 5A-5C. Studying the bandwidth utilization on the first 7 days on the observed graph depicted in FIG. 1C illustrates that bandwidth utilization on Saturday (day 7) and Sunday (day 1) is lower than the rest of the week. Additionally, it can be seen that bandwidth utilization follows similar patterns for week days, e.g., Monday-Friday.

Additionally, the bandwidth utilization pattern is approximately periodic for the weeks that follow unless a drastic change in data utilization usage of the client node occurs. For example, bandwidth utilization patterns during coming Mondays ought to be similar to the bandwidth utilization pattern observed during the previous Monday. That is, bandwidth utilization pattern over different weeks is periodic. Similarly, such periodicity may also be observed on a monthly basis. That is, in the absence of any substantial change in network usage or architecture, bandwidth utilization pattern over a month is substantially similar to the bandwidth utilization pattern observed in the previous months.

Furthermore, the activity on a given day typically does not affect the activity seen on a different day. For example, the bandwidth utilization on a Monday does not affect the bandwidth utilization seen on a Tuesday or vice versa. In this way, a bandwidth utilization model can be generated for each day of the week as opposed to a much longer segment of time such as a week or month, which would allow for a significantly smaller number of samples to be required to create a single prediction model, which would therefore lead to significant computational savings when training and updating bandwidth utilization models.

In this case, assuming a model is created for each day of the week, the amount of data points needed to train the model would be 1/7^{th} the amount of data needed to create a single model for the entire week. Thus, 7 separate models would be trained for each day of the week instead of one large model for the entire week, which, depending on the computational resources available, may be preferable. This property is exploited to perform the model training on a network interface device, which has significantly less processing resources than a data center or server cluster.

In an embodiment, the periodic nature of bandwidth utilization is used to predict future bandwidth utilization of customers of a connectivity service provider. For example, once a model (pattern) is learned for bandwidth utilization over time for a week, this model may be used to predict bandwidth utilization over time for the week that follows.

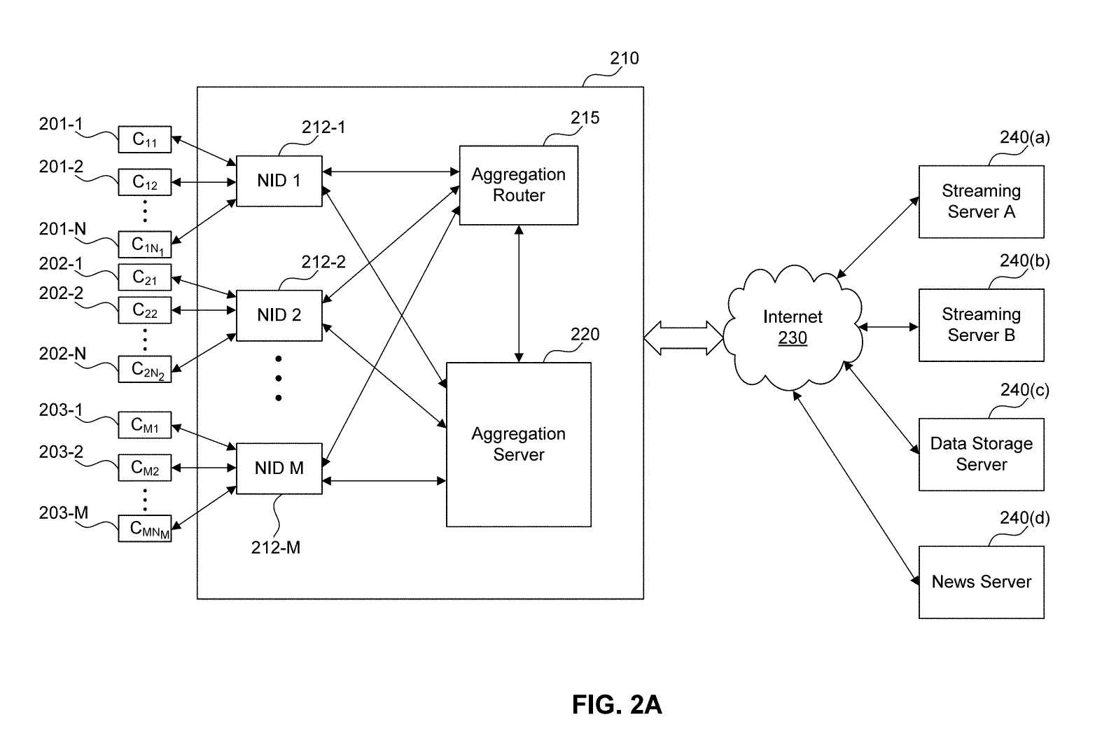

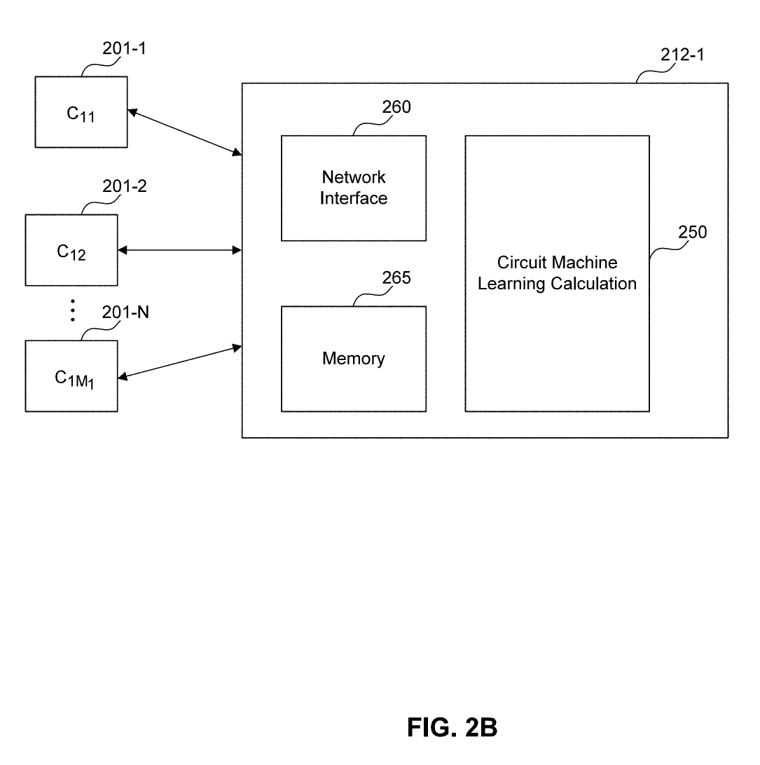

FIG. 2A illustrates an embodiment of the connectivity service provider including NIDs that determine bandwidth utilization models and multiple modules for collecting and storing utilization data and the bandwidth utilization models. The overall connectivity service provider 210 contains all of the devices and modules that are required to train and store the bandwidth utilization data and bandwidth utilization models, as well as the interfaces required to display that information to the customers that own the client nodes. The connectivity service provider contains network interface devices (NIDs) 212-1 through 212-M, an aggregation router 215, and an aggregation server 220 which contains the necessary modules for storing utilization data, prediction models, and interfacing for customers.

Client nodes 201-1 through 201-N, 202-1 through 202-N, and 203-1 through 203-M, as discussed before, may each represent the edge routers or hubs on in a client network which connect a LAN or enterprise network to the connectivity service provider. These nodes are owned by customers of the connectivity service provider that may wish provide service to office buildings, store fronts, and other similar facilities for their employees or their own customers. Similar to FIG. 1A-B, these nodes are connected to the connectivity service provider through NIDs 212-1 through 212-M, which act as the final hop controlled by a connectivity service provider, i.e. they are the edge, or “gateway,” routers for the connectivity service provider's network. Each NID routes ingress and egress traffic between the client nodes and the internet. It should be noted that each group of client nodes 201-1 through 201-N, 202-1 through 202-N, and 203-1 through 203-M connected to each NID are not necessarily the same number of client nodes, but are labeled as such for simplicity.

The ingress and egress data traffic is routed from one client node through its respective NID to an aggregation router 215. The aggregation router acts as a point of arrival and departure for all traffic served through the connectivity service provider to and from the internet. Thus, each NID contains a bidirectional communication link with the aggregation router. As described before, each client node is associated with a “circuit,” and all ingress and egress traffic is associated with a circuit.

The NID also has a bidirectional communication link to the aggregation server 220. The aggregation server 220 serves as the central repository for historical bandwidth utilization data for each client node and the most updated bandwidth utilization models for each client node circuit. The aggregation server may contain multiple server devices configured to work in concert, such as a blade server configuration, to provide storage and processing power for large operations. As described above, the NID device provides the utilization data and updated bandwidth utilization model data per circuit to the aggregation server. Both the NID and aggregation server can use existing protocols to transmit data, such as the simple network management protocol (SNMP).

The utilization data records the amount of bandwidth that is used in bits per second (BPS) for a particular time slice for each circuit for either ingress traffic, egress traffic, or both. The bandwidth utilization model predicts the BPS for a particular time slice in a corresponding future time period. For example, the model may predict the ingress bandwidth utilization in BPS for a 5-minute time slice on a given day of the week, such as 3:00-3:05 PM on Monday. In some embodiments, the utilization data (but not the bandwidth utilization models) may be provided to the aggregation server by the aggregation router 220.

Client nodes 201-1 through 201-N, 202-1 through 202-N, and 203-1 through 203-M may use connectivity service provider 210 to receive data from the internet 230, which would then connect those client nodes to a variety of content providers, such as streaming servers 240(a) and 240(c), data storage server 240(c), news server 240(d), or other servers such as a cloud server (not shown). The client nodes may use connectivity service provider 210 to also send (upload) data to a variety of servers.

A simple example of the system is in order. A client node 201-1 may serve as the aggregation point for all traffic going to individual devices connected to that client node's network, such as a coffee shop. The coffee shop itself may use one or a series of wireless IEEE 802.11 access points to serve its patrons' wireless devices such as laptops and smartphones. All traffic coming from and sent to those patrons' devices would then be served through the client node 201-1 and through the connectivity service provider by way of NID 212-1. This client node's connection to the connectivity service provider via NID 212-1 would constitute a single circuit, and all of the data traveling to and from this client node would be monitored to generate bandwidth utilization data (in BPS, for example) as well as a regularly-updated bandwidth utilization model. The traffic for this coffee shop would travel the network path from client node 201-1 to NID 212-1 to aggregation router 215, then from the aggregation router to the internet 230 and the various streaming, data, and other storage servers 240(a)-(d) as described above. For all traffic that comes to and from the client node, bandwidth utilization data is generated at NID 212-1 that notes the BPS usage for that client node at for some time slice (e.g. every 5 minutes), and that data is forwarded to the aggregation server 220. That utilization data is also used to create or update a bandwidth utilization model. At the same time, this customer may also own various other coffee shops in neighboring areas that may be served by different client nodes and different NIDs within the same connectivity service provider 210.

FIG. 2B illustrates the functional modules of a NID device 212-1 through 212-M. The NID serves the dual purposes of being the “gateway” node into the connectivity service provider for each of the client nodes. The NID contains a network interface card 260 which allows for bidirectional communication with the client nodes 201-1 through 201-N, the aggregation router 215, and the aggregation server 220. This interface will typically be through well-known existing hardware such as ethernet cards following the IEEE 802.3 standard. The NID device will also contain memory 265 that allows for storage of short-term utilization data history as well as the existing bandwidth utilization models for each of the circuits served by the NID. Finally, the NID will contain a circuit machine learning calculation module 250, which performs the training of the bandwidth utilization model using the updated bandwidth utilization data. The training process can take the form of many existing machine learning techniques, including regression and kernel-based learning. These will be described in detail below.

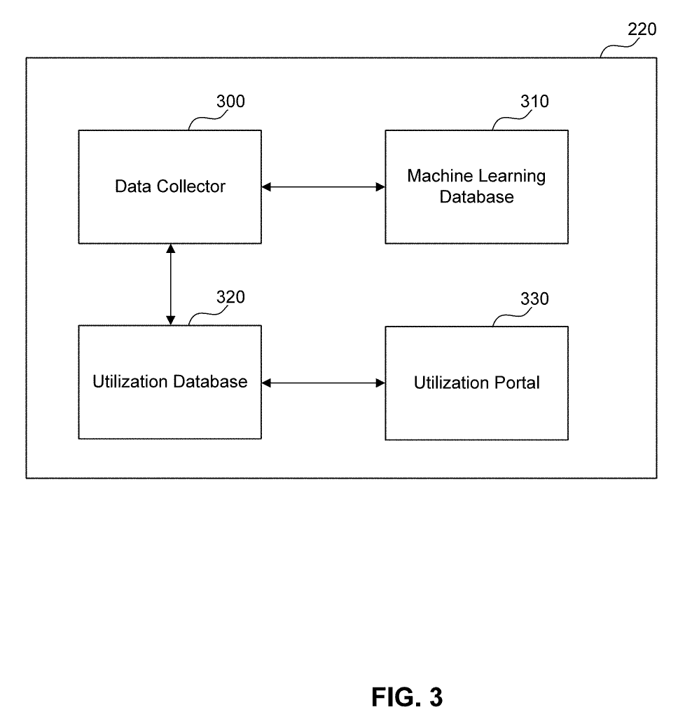

FIG. 3 illustrates the functional modules of the aggregation server 220. As previously described, the main purpose of the aggregation server and its component modules is to store utilization data, bandwidth utilization models, and allow interfacing with customers to observe the utilization data and predicted utilization for each of their client nodes. The data collector module 300 is responsible for allowing two-way communication with the NIDs 212-1 through 212-M and aggregation router 215 within connectivity service provider 210 to collect bandwidth utilization data and updated bandwidth utilization models. In various embodiments, the utilization data may come from either the NIDs themselves or from the aggregation router. The updated models come only from the NIDs. This module is also used to load the existing bandwidth utilization models for an upcoming day to a NID. For example, sometime before midnight on a Tuesday morning, the aggregation server may upload to NID 201-1 all of the utilization models for Tuesdays for the circuits served by NID 201-1.

The aggregation server 220 also contains a utilization database 320 which is responsible for storing all historical bandwidth utilization data for each circuit as it arrives from each individual NID. The ML database 310 is responsible for storing the most recent utilization model for each circuit, and for initiating the transfer of existing models for all circuits to their respective NIDs so that the models can be updated by the NID as necessary. This process is described further with respect to FIG. 5A-5C. Finally, the aggregation server also contains a utilization portal 330. The utilization portal may be a server that maintains individual accounts for different customers of connectivity service provider 210. These individual accounts will maintain a list of all circuits that serve the customer's client networks, and allow for visualization of the historical usage and predicted usage of each of the customer's circuits. Utilization portal 330 may include a graphical user interface that, upon request, provides a graphical display of each customer's historical, current, or predicted bandwidth utilization over time such as the graphical display shown in FIG. 1C. In an embodiment, utilization portal 330 may provide a graphical display for observed or predicted bandwidth utilization that scrolls over time axis as new bandwidth utilization data versus time is received.

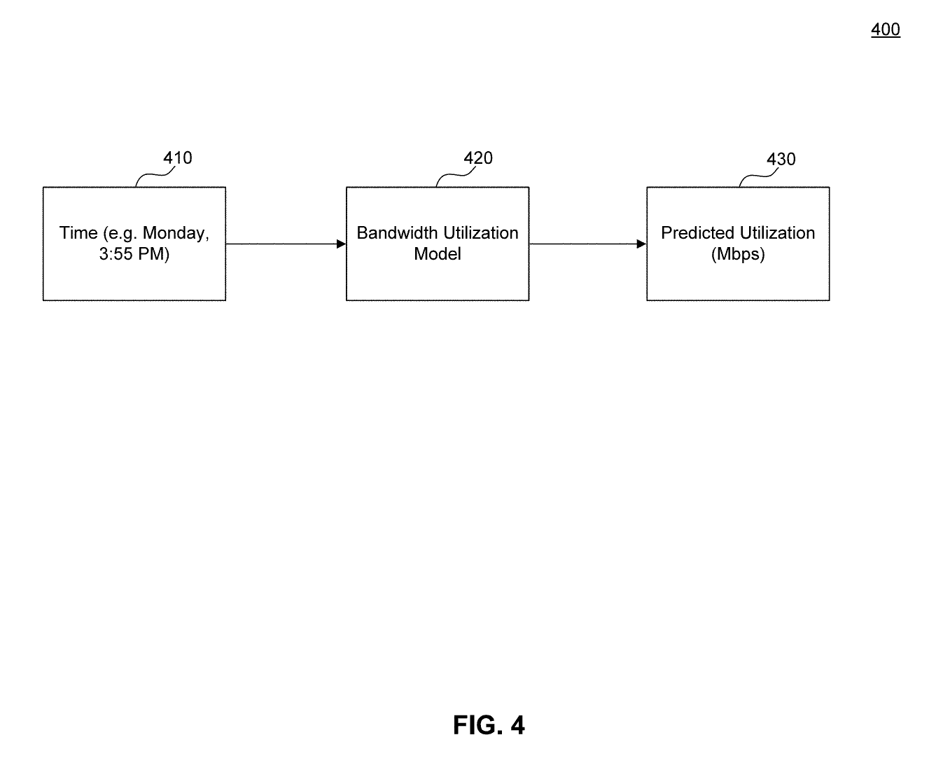

FIG. 4 is a simple illustration of a system which uses the bandwidth utilization model to predict bandwidth utilization at a future time for a particular client node. As was described relative to FIG. 1C, the bandwidth utilization model attempts to predict the bandwidth utilization of a particular circuit at a future time in a system where the bandwidth utilization is assumed to be periodic. For example, an office building could expect to see relatively high usage on typical weekdays (Monday-Friday) during normal work hours, for example 8 AM-5 PM, and significantly lower usage in evenings and on weekends generally owing to the likely absence of office workers in the office building during those times.

Thus, FIG. 4 reflects that scenario. At 410, a time slice within a given time period to be predicted is selected, for example Monday at 3:55-4:00 PM. This time period is input into the bandwidth utilization model 420, and a predicted utilization 430 is output in units of average megabits-per-second (Mbps). Thus, the predicted bandwidth utilization could be obtained for a range of times such as Monday from 12 AM-11:55 PM. This predicted bandwidth utilization could then be compared against the actual bandwidth utilization.

FIGS. 5A, 5B, and 5C all relate to the training process by which a bandwidth utilization model is created or updated by the NID. The training process may be a machine learning process such as regression. In an embodiment, the learned bandwidth utilization model during a time period may be used to predict bandwidth utilization of the customer during future time periods. In other words, the model, once completed, describes the predicted bandwidth utilization for all times within a particular time period. For example, a model might give a predicted utilization for every 5-minute time slice (such as 10:45-10:50, 10:50-10:55, 10:55-11:00, and so on) for every day of the week, adding up to 2016 predictions (12 5-minute periods per hour, 24 hours per day, 7 days, per week). The length of the time slice may be adjusted depending on the desired granularity of the model and the processing resources available for performing the training.

The regression process attempts to find or update a relationship between bandwidth utilization and time, where the bandwidth utilization is assumed to be a function of time. The regression process may, for example, be a linear regression. In this case, a general model such as a linear or a polynomial relationship between bandwidth utilization and time is considered. The model is then trained based on the time series that describes bandwidth utilization over time during the time period. During the training, a value for one or more parameters is determined that describes bandwidth utilization as a linear combination of the one or more parameters (but not necessarily linear in the independent variables).

Alternatively, the regression process may be a non-linear regression such as kernel-based regression. In embodiments, kernel-based regression is used where the model defining the relationship between bandwidth utilization and time is a sum of a plurality of kernel functions each evaluated at a data point and weighed by a parameter that is to be determined based on the given utilization data over time. Therefore, the dependent variable, in this case bandwidth utilization, can be modeled as the sum of several weighted kernel functions. Several kernel functions exist that can be utilized in this regression, for example a polynomial of various degrees, a sigmoid function, a radial basis function (RBF), etc.

Because it is assumed that the bandwidth utilization on one day of the week is not dependent on the bandwidth utilization of another day of the week, models that predict the utilization of one day of the week (e.g. Tuesday) can be created independently of the models for the other days of the week (e.g. Monday). This is important for bandwidth utilization models created on a network interface device because the amount of data and processing resources required is significantly smaller for a daily model rather than a weekly model.

In embodiments, at the end of the training process, a value for one or more parameters is determined (or updated) based on the bandwidth utilization data over time for the time period. The training can come in two forms called “batch” and “online” training. In batch training, a model is updated a single time based on all of the data collected that is pertinent to that model. For example, a set of bandwidth utilization data points for every 5-minute time slice on a Monday would be gathered and used in the training algorithm to create or update the bandwidth utilization model for Mondays. On the other hand, an “online” training algorithm may take one or more data points within that Monday and create or update the Monday model immediately, and subsequently update the model several times with more data points as that data becomes available.

In an embodiment, a model describing daily bandwidth utilization over time is determined based on bandwidth utilization over time received over the first N weeks. On the (N+1)^{th} week, as more bandwidth utilization data over time becomes available corresponding to Monday, the weekly model is updated to incorporate the new utilization data. As the newly received bandwidth utilization data corresponds to Monday, it does not affect the model in the time instances outside Monday, e.g., Tuesday etc. This may make the model robust and resilient to data loss that may be experienced for a duration of time. For example, if bandwidth utilization data for the previous Friday is lost, this loss does not affect the accuracy of the obtained bandwidth utilization model in the time instances that do not correspond to Friday (e.g., Monday).

FIG. 5A illustrates a flowchart for method 500 of analyzing bandwidth utilization data to create or update a bandwidth utilization model at a NID 212-1 through 212-M in an “online” learning algorithm. The method begins at step 510 with the receiving an existing model for a circuit served by the NID for an upcoming time period from the ML database 310. In some embodiments, the NID may request the existing model for an upcoming day at some time before that day begins (e.g. requesting at 11 PM on Monday the model for Tuesday 12 AM-11:55 PM), and the ML database sending the existing bandwidth utilization model back to the NID via the aggregation server's network interface module 222. In other embodiments, the ML database may simply push the existing model to the NID at a pre-determined time.

At step 515, the time period begins. At this point, steps 520, 522, and 524 repeat themselves for every time slice within the time period, which is a small duration of time within the time period. Typically, a time period ranging from 1-10 minutes should suffice to produce a sufficiently granular visibility into actual and predicted utilization without the model being too sensitive, or “over-fitted.” The utilization data and predicted values typically represent an average of the utilization within that time slice, as a time slice that is too small (for example, a 5-second time slice) may be too erratic to predict from one week to another. Thus, a time slice on the order of minutes removes some of this noisiness. For the time period of 12 AM on Tuesday to 12 AM on Wednesday, if the time slice chosen is 5 minutes, then time slices will be from 12:00-12:05, 12:05-12:10, 12:10-12:15, and so on until 12 AM on Wednesday, and at every time slice, steps 520 through 524 will be repeated.

During this time period, utilization data for a circuit is generated by the NID in step 520 based on the ingress or egress traffic seen for a particular circuit within that time slice. At step 522, the NID sends the data to the aggregation server's utilization database 320. Meanwhile, in step 524, the utilization data generated in step 520 is used to update the bandwidth utilization model at the NID. This particular step reflects the “online” algorithm—the bandwidth utilization model is updated as utilization data is generated throughout the time period instead of waiting for the time period to end and using all of the utilization data at once. However, the NID does not send the updated model to the utilization database in the utilization model. Steps 520, 522 and 524 repeat as long as the time period has not ended. When the time period has not ended, at step 526, a “NO” output is generated thereby repeating the loop of steps 520, 522 and 524.

Once the time period has ended, at step 530 the updated bandwidth utilization model is sent to the aggregation server's ML database 310. This model is then used to predict the bandwidth utilization in future times corresponding to the time period just completed. For example, if the time period completed is a Tuesday, the updated model will then be used to predict bandwidth utilization for the following Tuesday. At step 535, the NID may flush its own memory module 265, deleting the utilization data and the updated bandwidth utilization model for the time period that has passed.

FIG. 5B illustrates a flowchart for method 550 of analyzing bandwidth utilization data to create or update a bandwidth utilization model at a NID 212-1 through 212-M in a “batch” learning algorithm. The method is nearly identical to method 500, and the steps that are identical are labeled identically with their counterparts in method 500. For example, at 510, the existing bandwidth utilization model for a circuit served by the NID for an upcoming time period is received from the ML database 310. Then, after the time period begins, the NID periodically generates utilization data for the circuit based on its egress or ingress traffic, and sends that utilization data to the utilization database 320 at steps 520 and 522. Similar to method 500, steps 520 and 522 are repeated for every time slice within the time period as described above.

Once the time period is over, at step 526, a YES output is generated. Step 528 represents the key difference between method 500 and method 550. In method 500, the existing bandwidth utilization model is periodically updated in step 524 as new utilization data is generated, so that, for example, the existing model may be updated every 5 minutes as new utilization statistics are generated by the NID. In method 550, after the entire time period has ended, all utilization data generated during the time period is used at once to update the bandwidth utilization model once in what is called a “batch” algorithm. Following the updating of the utilization model, at step 530, the updated model is sent to the ML database 310 at step 530, and the utilization data and utilization model for the now-expired time period may be deleted from memory 265 at step 535.

FIG. 5C illustrates a flowchart for a method 570 that depicts when the NID receives and sends the bandwidth utilization models to ML database 310. This method demonstrates how the online or batch algorithms of methods 500 and 550 operate continuously as new time periods start while still sending updated models back to the ML database 310. At step 575, the existing model for an upcoming time period for a circuit served by the NID is received from the ML database 310. At step 577, the upcoming time period starts, which consists of the two component steps of generating utilization data for the circuit based on its ingress/egress traffic and updating the existing model. During this time period, a model for a now-expired time period has either been updated completely (if the online algorithm is used) or is in the process of being updated.

After the model for the previous time period has been completely updated, at step 579 the updated model for the previous time period is sent to the ML database 310 and the utilization data and updated model information is cleared from the NID's memory module. Step 579 may be set at a predetermined time during the current time period by the aggregation server such that multiple NIDs do not all try to send their respectively updated utilization models at once causing a potential distributed denial-of-service (DDOS) issue. Generally, the NID will send the model for the previous time period up to the ML database early in the current time period, so, for example, an updated model for Monday's utilization may be sent in the early morning hours of Tuesday. The NID will be simultaneously generating utilization data and updating the Tuesday model while the Monday model is being sent up to the ML database.

The process then repeats itself indefinitely as shown by the next step of 579 being the receiving step 575. At that point, the current time period will be approaching its expiration and the NID is preparing to generate new utilization data and update the utilization model of the next time period.

Thus, during the current time period, the NID is generating utilization data, updating the model for the current time period if the online mode is being used, and at some point also sending the model for the previous time period up to the ML database 310. Therefore, two models at most are being stored in the NID at one time—the updated model for the previous time period, and the model for the current time period that is being updated in either the online or batch mode.

An example is in order to demonstrate this functionality. At some time before 12 AM of Tuesday, for example 11:50 PM of Monday, the existing model for the 24 hour period starting at Tuesday 12 AM for a circuit served by the NID is received from the ML database 310. At 12 AM on Tuesday, the time period has now started, so utilization data is being generated by the NID for that circuit based on its traffic pattern. In “online” mode, the utilization model for Tuesday will be getting updated periodically based on the newly generated utilization data for Tuesday. In “batch mode” the utilization data will be generated and stored in memory to update the utilization model all at once.

Meanwhile, the NID will be completing whatever remaining updates are needed for the Monday model, and sending the updated Monday model to the ML database 310 at a time predetermined by the aggregation server or based on some other transmission policy. After sending the model to the aggregation server, the NID will clear any utilization or model data relating to Monday from its memory, as it is no longer pertinent to the current operation. Later on, at a similar time (e.g. 11:50 PM on Tuesday), the existing model for Wednesday for a circuit served by the NID will be received form the ML database. Then as Wednesday begins, whatever is remaining of the Tuesday model updates will be completed, sent to the ML database, and purged from memory while the NID also generates utilization data and updates the model for Wednesday. This process is repeated indefinitely.

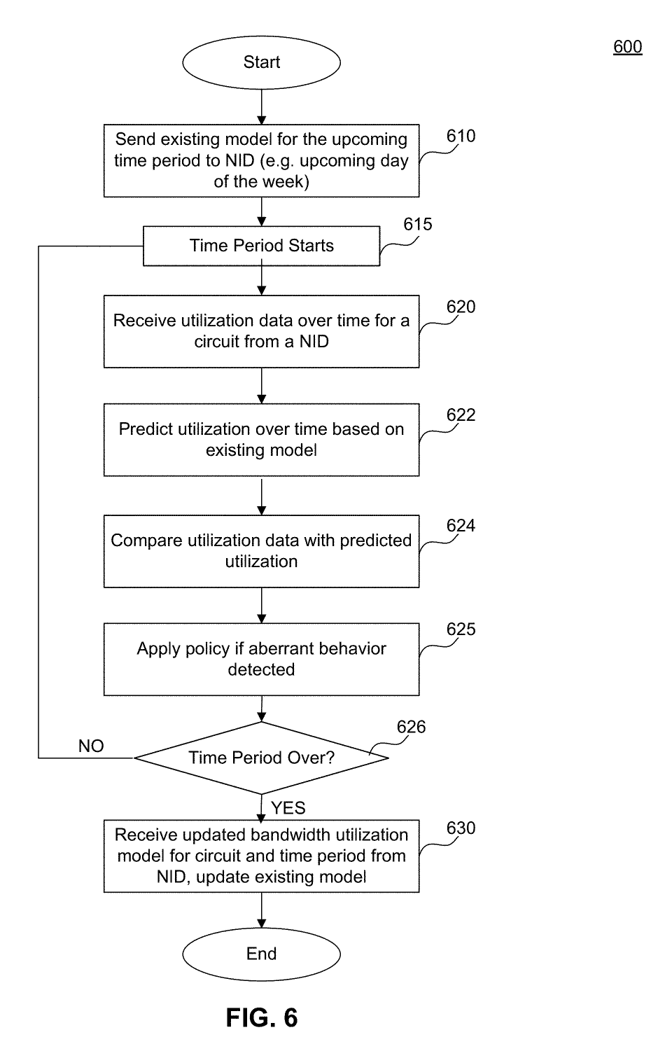

FIG. 6 illustrates a flowchart for method 600 implemented on the aggregation server to interact with the NID so that the NID can update the bandwidth utilization model. The method also details the aggregation server's use of utilization data from the NID to flag potential issues by comparing this data with the predicted utilization. Several of the steps in method 600 are counterparts of steps in methods 500 and 550 from the perspective of the aggregation server, and will be pointed out as such.

Method 600 begins with step 610 in which a model for an upcoming time period for a circuit is sent to the NID serving that circuit. This step is the counterpart to step 510 in which the NID receives that utilization model. As described previously, this model may be sent at a pre-determined time determined by the aggregation server, or it may be sent upon receiving a request from the NID. At step 615, the upcoming time period begins, thereby becoming the “current” time period. At this point, just as in methods 500 and 550, several steps repeat themselves until the time period ends. At step 620, utilization data for the circuit is received from the NID. This step is the counterpart to step 520 in methods 500 and 550. At step 622, the aggregation server predicts the usage at the time slice corresponding to the utilization data that is received at step 620. As mentioned before, this prediction can be determined by inputting the current time into the existing model as seen in method 400 of FIG. 4. It should be emphasized that this prediction is based on the existing model before any updates to the existing model occur. This is true for two reasons: (i) as a practical matter, the NID is updating the model, and thus the aggregation server would not have visibility into the updated model if the NID has not yet sent the updated model to the aggregation server, and (ii) the prediction should not be based on the usage occurring at that moment, because a goal of the aggregation server is to determine if the current utilization by the circuit is aberrant compared to some expected value of utilization.

In step 624, the utilization data received by the NID is then compared to the predicted utilization obtained at step 622 to determine if the utilization of the circuit is aberrant compared to its predicted value. Several criteria can be applied to determine this aberrance, such as simple thresholds applied to the difference between the predicted utilization and the actual utilization represented by the utilization data. If the difference is larger than a threshold, such that the actual utilization is higher than or lower than the predicted utilization by some unacceptable amount, this circuit can be flagged in this time slice.

Following this step, a policy can be applied in step 625 as warranted by the connectivity service provider. The policy itself could take many forms. For example, the connectivity service provider may notify the customer by flagging the customer account and reflecting this flag in the customer's portal page. Additionally or alternatively, the connectivity service provider may police the data relayed for the customer to determine whether a network security attack is taking place. Furthermore, the connectivity service provider may examine the route between the customer and internet (e.g. internet 230) to determine whether a link failure has caused higher end-to-end delay and/or packet loss resulting in lowered bandwidth utilization. Additionally or alternatively, the customer may monitor the network usage of its end users to detect potential suspicious activity or network abuse.

If the time period has not yet expired, a NO output is generated at step 626 and steps 620-630 are repeated for the next time slice. If the time period has expired, a YES output is generated at step 630 and the same process can be started for the next time period. Meanwhile, at step 630, the updated model for the time period that has just expired is received by the aggregation server and stored in the ML database 310. This may overwrite the existing model stored in the ML database for the time period for that circuit. When the time period recurs the following week, this updated model is used to perform the utilization prediction in step 624, while the NID again updates the model for that time period.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The exemplary embodiments described above are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following detailed description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for calculating a bandwidth utilization model at a network interface device (ND) of a customer service provider (CSP) network, comprising:
collecting, at the ND, bandwidth utilization data for a circuit associated with a customer network, the bandwidth utilization data comprising utilization metrics for time slices within a time period, wherein the ND serves as an edge router between the customer network to the CSP network;
forwarding, from the ND, the bandwidth utilization data to a utilization database within the CSP network;
receiving, at the ND, the bandwidth utilization model corresponding to the circuit for the time period from a machine learning (ML) model database within the CSP network;
training, at the ND, an updated bandwidth utilization model for the circuit based on the bandwidth utilization model and the bandwidth utilization data corresponding to the time period; and
sending, from the ND, the updated bandwidth utilization model to the ML database at a sending time after the time period, wherein the updated bandwidth model forecasts bandwidth utilization at time slices during a future time period according to the utilization of respective time slices during the time period.

2. The method of claim 1, further comprising deleting, at the ND, the updated bandwidth utilization model from a memory of the NID after the bandwidth utilization model has been sent to the ML database.

3. The method of claim 1, wherein the ML database, before receiving the updated bandwidth model, uses the bandwidth utilization model to provide a prediction of bandwidth utilization corresponding to a time slice to compare with the utilization data corresponding to the time slice from the utilization database.

4. The method of claim 1, further comprising sending, from the NID, egress data from the circuit to an aggregation router, and receiving, at the NID, ingress data for the circuit from the aggregation router.

5. The method of claim 1, wherein the sending is done using the Simple Network Management Protocol (SNMP).

6. The method of claim 1, wherein the bandwidth utilization data corresponds to one of ingress data or egress data.

7. The method of claim 1, wherein the time period is at least one day and at most seven days.

8. The method of claim 1, wherein the bandwidth utilization model and the updated bandwidth utilization model are kernel-based machine learning models.

9. The method of claim 1, wherein the sending time is not more than one day after the time period has ended.

10. A system for providing a bandwidth utilization model for a circuit associated with a customer network of a connectivity service provider (CSP) network, the system comprising:
an aggregation router;
a network interface device (NID) that serves as an edge router connecting the customer network to the CSP network, comprising:
a network interface module configured to:
forward bandwidth utilization data for a circuit associated with a customer corresponding to the utilization database, wherein the utilization data comprises utilization metrics for time slices within a period of time,
receive the bandwidth utilization model corresponding to the time period from a machine learning (ML) database, and
send an updated bandwidth utilization model corresponding to the time period to the ML database at a sending time after the time period has ended such that the updated bandwidth model forecasts bandwidth utilization at time slices during a future time period according to the utilization of respective time slices during the time period;
a memory configured to store the bandwidth utilization model and the bandwidth utilization data corresponding to the time period; and
a machine learning module configured to train the updated bandwidth utilization model using the bandwidth utilization model and the bandwidth utilization data corresponding to the time period, wherein the training of the updated bandwidth utilization model comprises determining values for a set of parameters; and
an aggregation server comprising:
a data collector module configured to:
receive bandwidth utilization data from the NID,
send the bandwidth utilization model to the NID, and
receive the updated bandwidth utilization model from the NID at the sending time predetermined by the CSP network;
a utilization database configured to store the bandwidth utilization data; and
the ML database configured to store the updated bandwidth utilization model corresponding to the time period.

11. The system of claim 10, wherein the network interface module is further configured to send egress data from the circuit to an aggregation router, and receive ingress data for the circuit from the aggregation router.

12. The system of claim 10, wherein the time period is at least one day and at most seven days.

13. The system of claim 10, wherein the bandwidth utilization model and the updated bandwidth utilization model are kernel-based machine learning models.

14. The system of claim 10, wherein the sending time is at most one day after the time period has ended.

15. The system of claim 10, wherein the bandwidth utilization data corresponds to one of ingress data or egress data.

16. The system of claim 10, wherein the memory is further configured to delete the updated bandwidth utilization model after the updated bandwidth utilization model has been sent to the ML database.

17. The system of claim 10, wherein the ML database is further configured to, before receiving the updated bandwidth utilization model, provide a prediction of bandwidth utilization for a time slice using the bandwidth utilization model to compare with the utilization data corresponding to the time slice from the utilization database.

18. A program storage device tangibly embodying a program of instructions executable by at least one machine to perform a method for providing a predicting bandwidth utilization for a customer of a connectivity service provider (CSP) network, the method comprising:
collecting, at a network interface device (NID), bandwidth utilization data for a circuit associated with a customer network, the bandwidth utilization data comprising utilization metrics for time slices within a time period, wherein the NID serves as an edge router between the customer network to the CSP network;
forwarding, from the NID, the bandwidth utilization data to a utilization database within the CSP network;
receiving, at the NID, the bandwidth utilization model corresponding to the circuit for the time period from a machine learning (ML) model database within the CSP network;
training, at the NID, an updated bandwidth utilization model for the circuit based on the bandwidth utilization model and the bandwidth utilization data corresponding to the time period; and
sending, from the NID, the updated bandwidth utilization model to the ML database at a sending time after the time period of the bandwidth utilization model such that the updated bandwidth model forecasts bandwidth utilization at time slices during a future time period according to the utilization of respective time slices during the time period.

19. The program storage device of claim 19, wherein the time period is at least one day and at most seven days.

20. The program storage device of claim 19, wherein the sending time is at most one day after the time period has ended.
